(19) United States
(12) Patent Application Publication
(10) Pub. No.: US 2012/0013453 A1
(43) Pub. Date: Jan. 19, 2012

(54) RFID Safety System and Method

(75) Inventors: Alan Wyne, Elkhart, IN (US); Daniel Brian Zakula, SR., Mokena, IL (US)

(73) Assignee: MI-JACK PRODUCTS, INC., Hazel Crest, IL (US)

(21) Appl. No.: 12/838,665

(22) Filed: Jul. 19, 2010

(51) Int. Cl. G08B 23/00; G08B 21/00; B60Q 1/00

(52) U.S. Cl. 340/425.5; 340/573.1; 340/686.6; 340/10.1

(57) ABSTRACT

The system and method for detecting and warning of the proximity of a hazard. In one embodiment this may be achieved by receiving a signal from a RFID tag, determining that the RFID tag is associated with a safety article, and activating a warning device. In another embodiment, a system may be provided that includes a monitoring antenna that receives data transmitted from a RFID tag coupled to a safety article and a processor that transmits a signal to a warning device if the safety article is in proximity to a hazard.

### BACKGROUND

There are many situations in industrial operations where workers, supervisors, observers, or authorized visitors are required to be in the vicinity of various hazards. The hazards may be moving vehicles, industrial or construction machines, or fixed hazards such as stacks of hot metal plates, vats of hazardous liquids or open pits/trenches.

Accidents in industrial operations often happen because a machine or vehicle operator or worker is unaware that another worker, a supervisor, observer etc. (collectively, “Observer”) is in close proximity to an operating machine, vehicle or other hazard. An operator driving a vehicle may accidentally injure an Observer when turning a corner, backing-up or maneuvering in an area with poor driver visibility. A machine operator may fail to shut-off a machine or warn an approaching Observer of danger because he fails to see the Observer. Also, in industrial situations, Observers are sometimes not aware of the placement of hazards such as hot metal, vats of hazardous substances, open pits/trenches etc. Thus, accidents may happen because an Observer fails to see a hazard in time to avoid walking/tripping into it or touching it. A need exists for a system and method of detecting people in the vicinity of a moving or stationary hazard and for providing a warning for the people and a warning for the operator.

### SUMMARY

The invention is generally directed to a method and system for detecting and warning of the proximity of a hazard. In one embodiment this is achieved by receiving a signal from a radio frequency identification (RFID) tag, determining that the RFID tag is associated with a safety article (as hereinafter defined), and transmitting a signal to activate a warning device.

In another embodiment, a system for detecting and warning of the proximity of a hazard is provided. The system comprises: a plurality of RFID tags coupled to a safety article, the plurality including a first RFID tag that transmits data to a first monitoring antenna, the data including the identification of the first RFID tag; a plurality of monitoring antennas, mounted on the vehicle, the plurality including a first monitoring antenna that receives the data transmitted from the first RFID tag; and a first processor, coupled to at least one of the plurality of monitoring antennas, that transmits a signal to activate a first warning device based on the identification of the first RFID tag.

Also provided is a system comprising: first and second RFID tags embedded in a safety article worn by a user, the first tag embedded in the front of the safety article and the second tag embedded in the back of the safety article; a plurality of monitoring antennas, mounted adjacent to a stationary hazard, the plurality including a first monitoring antenna that provides a first detection zone and that receives data transmitted from the first RFID tag when the first RFID is present in the first detection zone; a database that stores computer-readable instructions; a computer processor that executes the computer-readable instructions to determine, based on the data received from the RFID tag, whether the RFID tag is associated with a safety article; and a warning device that is activated by the processor if the safety article is detected by the first monitoring antenna.

The above-noted and other advantages of the invention will be apparent from the description of the invention provided herein with reference to the attached drawings.

### BRIEF DESCRIPTION OF THE DRAWINGS

FIG. 1A is a block diagram representation of an exemplary RFID System in accordance with an embodiment of the invention;

FIG. 1B is a block diagram representation of an exemplary RFID System in accordance with an embodiment of the invention;

FIG. 2A is a flow chart showing an embodiment of a method associated with the RFID System;

FIG. 2B is a flow chart showing an embodiment of a method associated with the RFID System;

FIG. 2C is a flow chart showing an embodiment of a method associated with the RFID System;

FIG. 3 is a top view of one embodiment of a normal drive vehicle that includes RF antennas for receiving RF signals from one or more RFID tags;

FIG. 4 is a block diagram of a portion of an exemplary RFID System for use with the vehicle of FIG. 3;

FIG. 5 is a top view of one embodiment of a transverse drive vehicle that includes RF antennas for receiving RF signals from one or more RFID tags;

FIG. 6 is a block diagram of a portion of an exemplary RFID System for use with the vehicle of FIG. 5;

FIG. 7 is a perspective view of another embodiment of a vehicle that may be used in the systems of FIG. 1A-B;

FIG. 8 is a block diagram of a portion of an exemplary RFID System for use with the vehicle of FIG. 7;

FIG. 9 is a perspective view of another embodiment of a vehicle that may be used in the systems of FIG. 1A-B;

FIG. 10 is a top view of one embodiment of a vehicle that includes RF antennas for receiving RF signals from one or more RFID tags;

FIG. 11 is a block diagram of a portion of an exemplary RFID System for use with the vehicle of FIG. 10;

FIG. 12 is a perspective view of one embodiment of a stationary hazard that may be used in the system of FIG. 1;

FIG. 13 is a top view of one embodiment of a stationary hazard with RF antennas mounted for receiving RF signals from one or more RFID tags; and

FIG. 14 is a block diagram of a portion of an exemplary RFID System for use with the stationary hazard of FIG. 13.

### DETAILED DESCRIPTION OF THE EMBODIMENTS

The embodiments of the invention described below are not intended to be exhaustive or to limit the invention to the precise structure and operation disclosed. Rather, the embodiments described below have been chosen and described to explain the principles of the invention and its application, operation and use in order to best enable others skilled in the art to follow their teachings.

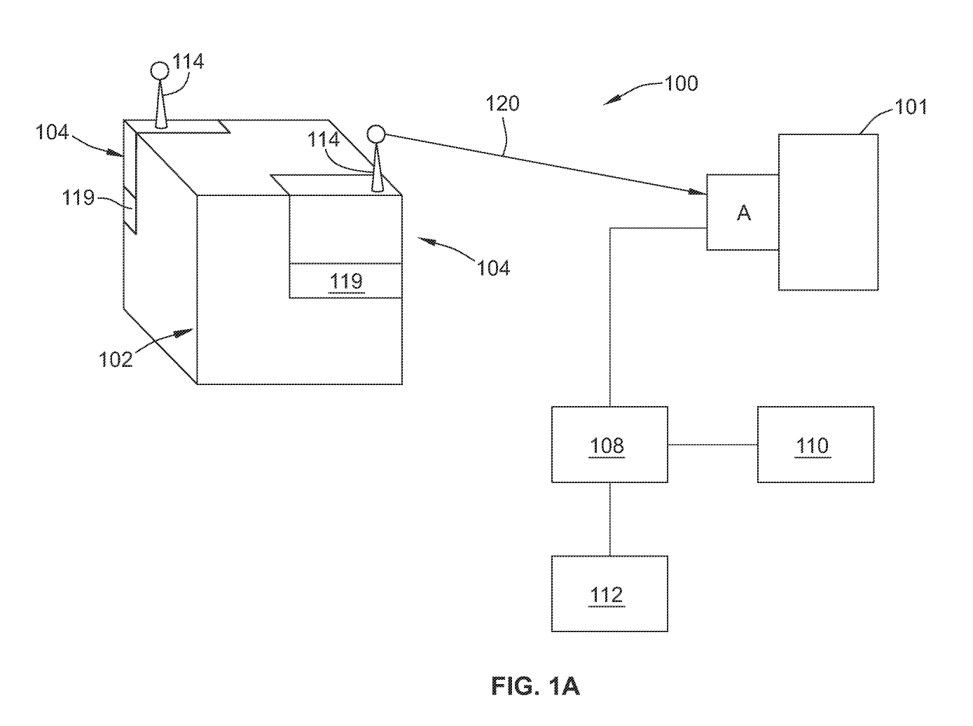

This invention is generally directed to a system and method for detecting and warning of the proximity of a hazard. Various embodiments of the radio frequency identification (RFID) system 100 are illustrated in FIGS. 1A-B. The embodiments shown in FIGS. 1A-B comprise a safety article 102 that includes at least one RFID tag 104 coupled to the safety article 102, a monitoring antenna A in communication with a processor 108, memory 110 coupled to the processor 108, and a warning device 112 coupled to the processor 108. Warning devices 112 may include, but are not limited to, a horn, lights, flashing lights, vibrator, buzzer or the like. A warning device 112 may be a device that shuts off, slows down or temporarily halts the operation of a hazard or notifies the operator of the detection of an Observer that is wearing the safety article 102. The warning device may be integrated into machine controls that control movement of the hazard. The warning device may be a display in or on a hazard, or otherwise, that advises an operator of the hazard of the detection of an Observer and, in some embodiments, of the approximate location of the Observer with relation to the hazard (for example, left front side, right back side, and the like). The identification of the location of the Observer with relation to the hazard may be based on identification of the position of the antenna A, with respect to the hazard, that receives data from the RFID tag. Alternatively, the identification of the location of the Observer with relation to the hazard may be based on identification of the location of the antenna A that receives the strongest signal from the RFID tag. Other methods known in the art may be used to determine the position of the Observer (wearing a safety article) with relation to the hazard. Other warning devices may also be used. An auditory warning device may increase the volume and/or frequency of a warning sound with increasing proximity of an Observer to the hazard. A visual warning device may increase the number of activated warning lights, the brightness, color or frequency of flashing of the lights with increasing proximity of an Observer to the hazard.

When the RFID tag 104 is present in an area covered by a monitoring antenna A, the RFID tag 104 sends data over a link 120, such as a RF link, to the monitoring antenna A. The monitoring antenna is one, such as a RF antenna, that is capable of receiving data from a RFID tag 104. The data may include, but is not limited to, information identifying the RFID tag 104.

For the purposes of this disclosure, the term “safety article” may encompass any item worn or carried to which a RFID tag 104 is attached. In one embodiment, the safety article 102 is a vest with a first RFID tag 104 imbedded in the front of the vest and a second RFID tag 104 imbedded in the back of the vest. The front of the vest is the side of the vest that, when worn by a user, is disposed on the front of the user. The back of the vest is the side of the vest that, when worn by the user, is disposed on the back of the user. In other embodiments, the RFID tag(s) 104 may be attached to a belt, a coat or any other type of item worn or carried by a user. The RFID tag 104 is a commercially available RFID tag that is capable of sending out a signal to a monitoring antenna A associated with a hazard 101. The RFID tag 104 may be an active RFID tag, a semi-active RFID tag, or a passive RFID tag. An active RFID tag may be used in applications where a “detection distance”, the distance across which a signal may be sent by the RFID tag and detected by antenna A, of greater than 50 feet may be desired. A semi-active RFID tag may be used in applications where a detection distance of approximately fifty feet or less is desired. A passive RFID tag may be used in applications in which the detection distance desired is less than twelve feet.

In the embodiment illustrated in FIG. 1A, the RFID tag 104 is powered and transmits data to the monitoring antenna A. In the embodiment shown in FIG. 1B, the RFID tag 104 is powered and transmits data to the monitoring antenna A and also receives data from the monitoring antenna A. In the embodiments shown in FIGS. 1A-1B, the RFID tag 104 comprises an RFID antenna 114 and a power source 119. The power source 119 may be a battery, however, other types of power sources may be used without departing from the scope and spirit of the invention.

Hazards to be avoided may be moving ones, such as a vehicle, or stationary hazards such as stacks of hot metal plates, vats of hazardous liquids, or the like. At least one monitoring antenna A is mounted on or adjacent to the hazard. Typically, for a moving hazard, at least one monitoring antenna A is mounted on the hazard, but may also be mounted adjacent to the area in which a moving hazard is operating.

In an embodiment, a plurality of monitoring antennas A may be utilized to detect RFID tag(s) 104. Each monitoring antenna A communicates with a processor 108 via communication circuitry known in the art. When a RFID tag 104 is detected by a monitoring antenna A in its field of detection coverage, a signal is sent by the monitoring antenna A (via communication circuitry) to the processor 108. The signal includes, but is not limited to, the data received by the monitoring antenna A from the RFID tag 104. The field of detection may cover an acute, obtuse or 360 degree angle depending on the antenna A and the placement of the antenna. The detection distance may vary within a field of coverage depending on the RFID tag utilized. The processor is coupled to memory 110 that holds such RFID tag data received from the processor so that a determination may be made as to whether the RFID tag 104 is associated with a safety article. In some embodiments, the memory may provide organized storage of data, such as that provided by a database.

The processor 108, then determines whether the RFID tag 104 detected by the monitoring antenna 108 is a tag associated with a safety article 102 (as opposed to a RFID tag used for some other purpose such as the tracking or identification of packages, loads etc.). If the RFID tag 104 is associated with a safety article, the processor sends a signal to a warning device.

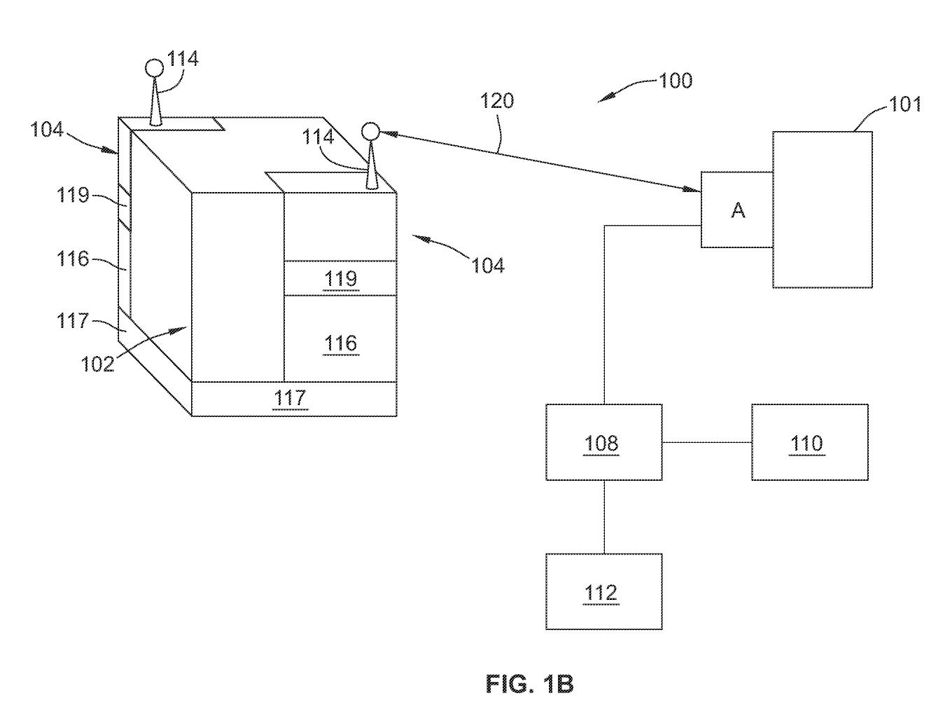

As illustrated by the embodiment shown in FIG. 2A, the processor 108 in step S202 receives information from the monitoring antenna or antennas A. The information received, by the processor 108 from monitoring antenna(s) A, includes data received from RFID tag(s) 104 within antenna A's field of detection coverage. The data may include identification of the RFID tag 104. In one embodiment, the detection distance may be between, and including, zero to approximately 50 feet distance between the RFID tag 104 and the monitoring antenna A. In other embodiments, the detection range may be lesser ranges or greater distances depending on the type of RFID tag 104 utilized. In an embodiment, in step S204, the processor 108 accesses memory 110 to determine whether the RFID tag 104 is associated with a safety article 102. In an embodiment, this may be done by comparing information identifying the RFID tag 104 to information saved in the memory. If the RFID tag is determined to not be associated with a safety article, the processor returns to the start of the flowchart in FIG. 2A. If it is determined that the RFID tag is associated with a safety article, the processor 108, in step S206, sends a signal to cause activation of a warning device(s) 112. This flowchart may be applicable to the embodiments disclosed in FIGS. 1A-B and 3-14.

In another embodiment, the RFID tag 104 may be coded with data that identifies the particular hazard of which the wearer of the safety article is to be warned. When the RFID tag 104 is present in an area covered by a monitoring antenna A, the RFID tag 104 sends data over a link 120, such as a RF link, to the monitoring antenna A. The monitoring antenna is one, such as a RF antenna, that is capable of receiving data from a RFID tag 104. The data may include, but is not limited to, information identifying the RFID tag 104 and its association with a safety article, and information identifying a hazard (or in some embodiments hazards) of which the wearer of the safety article is to be warned.

As illustrated by the embodiment shown in FIG. 2B, the processor 108 in step S210 receives information from the monitoring antenna or antennas A. The information received, by the processor 108 from monitoring antenna(s) A, includes information identifying such monitoring antenna(s) A and data received from RFID tag(s) 104. In an embodiment, in step S220, the processor 108 accesses the database 110 to determine the hazard(s) associated with the monitoring antenna(s) A from which information has been received. In step S230, the processor 108 compares the information received by the monitoring antenna(s) A from the RFID tag(s) 104 to information stored in the database 110 to determine whether such RFID tag(s) 104 is(are) associated with a safety article 102. If not, the processor returns to the start of the flowchart in FIG. 2B. In step S240, the processor 108 determines whether the hazard(s) that the wearer of the safety article 102 is to be warned of are the same as those which the monitoring antenna(s) A is(are) associated with. If not, the processor 108 returns to the start of the flowchart in FIG. 2B. If the hazard is one that the wearer of the safety article 102 is to be warned of, the processor 108 in step S250 sends a signal to cause activation of a warning device(s) 112. This flowchart may be applicable to the embodiments disclosed in FIGS. 1A-B and 3-14. In addition, some of the steps of the flow chart may be accomplished in a different order, or in parallel, or in other embodiments.

In another embodiment illustrated in FIG. 1B, the RFID tag 104 may include a processor and memory. When the RFID tag 104 is present in an area covered by a monitoring antenna A, the RFID tag 104 sends data over a link 120, such as a RF link, to the monitoring antenna A. The monitoring antenna is one, such as a RF antenna, that is capable of receiving data from a RFID tag 104. The data may include, but is not limited to, information identifying the RFID tag 104 and its association with a safety article, and information identifying a hazard (or in some embodiments hazards) of which the wearer of the safety article is to be warned. The RFID tag 104 may also receive data that may include instructions from the monitoring antenna A. In this embodiment, once the processor has determined that the RFID tag 104 is associated with a safety article, the processor may communicate instructions to the monitoring antenna A that the monitoring antenna A transmits over the communication link to the RFID tag 104. The RFID tag 104 communicates the instructions to its own processor 116 which then sends a signal to activate a safety article warning device 117 with which the RFID tag's processor 116 communicates. That safety article warning device 117 may be a vibrator attached to the safety article 102, a buzzer, lights or any other type of suitable warning device.

As illustrated by the embodiment shown in FIG. 2C, the processor 108 in step S252 receives information from the monitoring antenna or antennas A. The information received, by the processor 108 from monitoring antenna(s) A, includes data received from an RFID tag 104. In an embodiment, in step S254, the processor 108 accesses memory 110 to determine whether such RFID tag 104 is associated with a safety article 102. If not, the processor returns to the start of the flowchart in FIG. 2. If, yes, the processor 108 in step S256 sends response information to the monitoring antenna A for transmission to the RFID tag 104. The response information may include, but is not limited to, data or instructions to trigger the RFID tag's processor 116 to send a signal to activate a safety article warning device 117 on the safety article 102. The RFID tag 104 receives such data or instructions, and in response, in step 258, the RFID tag's processor 116 sends a signal to cause activation of a safety article warning device(s) 117 on the safety article 102. This flowchart may be applicable to the embodiments disclosed in FIGS. 1B and 3-14.

Various embodiments of the presently-disclosed system 100 may utilize different combinations and configurations than that illustrated in FIGS. 1A-B. For example, the processor 108 may comprise one or more computing devices interfacing with other components in the system 100 and storing data. The processor 108 may be disposed in the same general location of the hazard or may be located remotely from the hazard. In some embodiments, the processor 108 may comprise a remote server unit including memory for storing, and the remote server may be interfaced with one or more local processing units that receive identifying information from one or more RFID tags 104 via monitoring antennas A. The local processing units may also be coupled directly or indirectly to a mechanism(s) for activating a warning device(s) 112. In addition, data/information may travel between system components directly or indirectly. When appropriate, components may operate sequentially or in parallel.

Communication between system 100 components may, if appropriate, travel over communication networks such as the Internet, a local area network (LAN), wide area network (WAN), intranet or ethernet type networks etc. and over any combination of hard-wired or wireless communication links. The system 100 disclosed herein is not limited to any particular hardware architecture or configuration. Any suitable programming, scripting, or other type of language or combinations of languages may be used to implement the teachings contained herein. Such computing devices may include multipurpose processor-based computer systems that access stored software, application-specific integrated circuits and other programmable logic and combinations thereof.

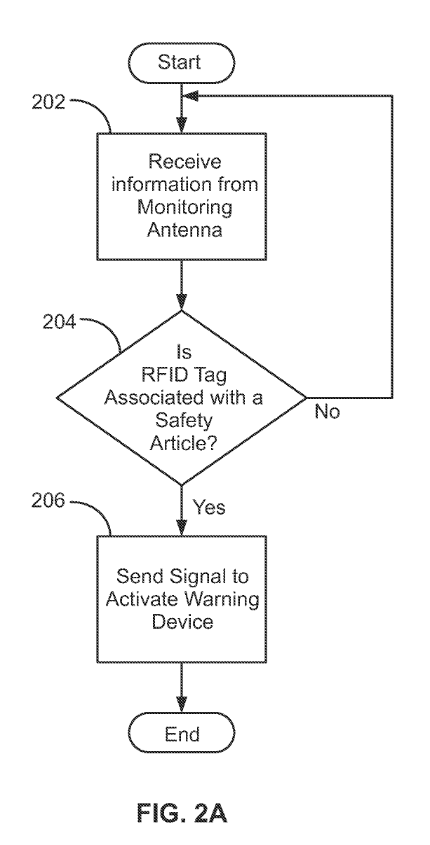

FIG. 3 illustrates one embodiment of the system in which a monitoring antenna is mounted on a moving hazard such as a vehicle. In this embodiment the vehicle 300 moves in “normal drive.” For the purposes of this disclosure, the term “normal drive” means that the vehicle 300 moves in the forward and backward direction as represented by the arrow in FIG. 3. Such a vehicle may have tires that move over the ground or may be mounted on devices, such as wheels, that move on rails. In one embodiment, the vehicle may be a crane used to lift and move loads. The crane may include four columns, one column at each corner.

In the embodiment shown in FIG. 3, four monitoring antennas A₁, A₂, A₃, A₄ are mounted on the vehicle 300. Each monitoring antenna A₁, A₂, A₃, A₄ is disposed on the vehicle 300 so that it detects signals within a particular detection zone or field of coverage 310, 312, 314, 316. In some embodiments, monitoring antennas A₁, A₂, A₃, A₄ may be positioned such that at least some monitoring antennas have overlapping detection zones (310 and 312; 314 and 316).

In the embodiment illustrated in FIG. 3, a monitoring antenna A₁, A₂, A₃, A₄ is mounted on each corner of the vehicle 300 and monitoring antennas A₁, A₂ are disposed such that the detection zone 310, 312 of each covers a portion of the front side of the vehicle 300 (forward drive direction). Monitoring antennas A₃, A₄ are disposed such that the detection zone 314, 316 of each covers a portion of the back side of the vehicle (backward/reverse drive direction).

In other embodiments a greater or lesser number of monitoring antenna may be used depending on the size of the moving hazard and the detection coverage desired. In one embodiment involving a crane, it is desirable to mount, at a minimum, one monitoring antenna on each crane column 320, 322, 324, 326. Also, in an embodiment, the monitoring antennas are mounted so that the front antennas A₁, A₂ have overlapping detection zones 310, 312 and these detection zones combined cover the entire front vehicle side. Similarly, the back antennas A₃, A₄ have overlapping detection zones 314, 316 and these detection zones combined cover the entire back vehicle side. The processor 108 and database 110 in the embodiment shown in FIG. 3 are disposed in the cab 330 of the vehicle 300. In other embodiments, the processor 108 and the database it accesses may be located elsewhere on the vehicle 300 or may be located remotely from the vehicle 300.

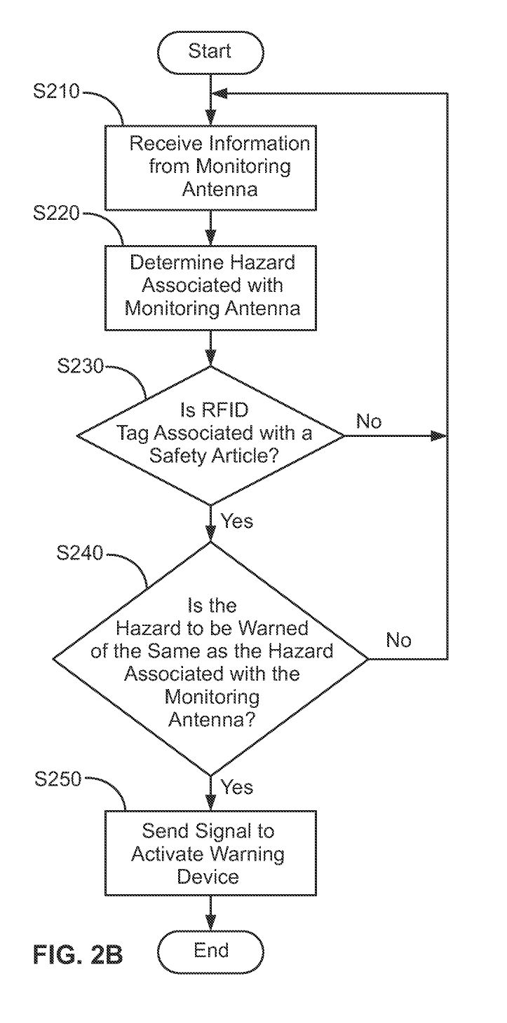

FIG. 4 illustrates the monitoring antennas A₁, A₂, A₃, A₄, processor 108, database 110 and warning device 112 for the embodiment of FIG. 3. As shown in FIGS. 3-4, the processor 108 communicates with each of the monitoring antennas A₁, A₂, A₃, A₄. If an antenna A₁, A₂, A₃, A₄ detects an RFID tag 104 within its detection zone, it transmits that information to the processor 108.

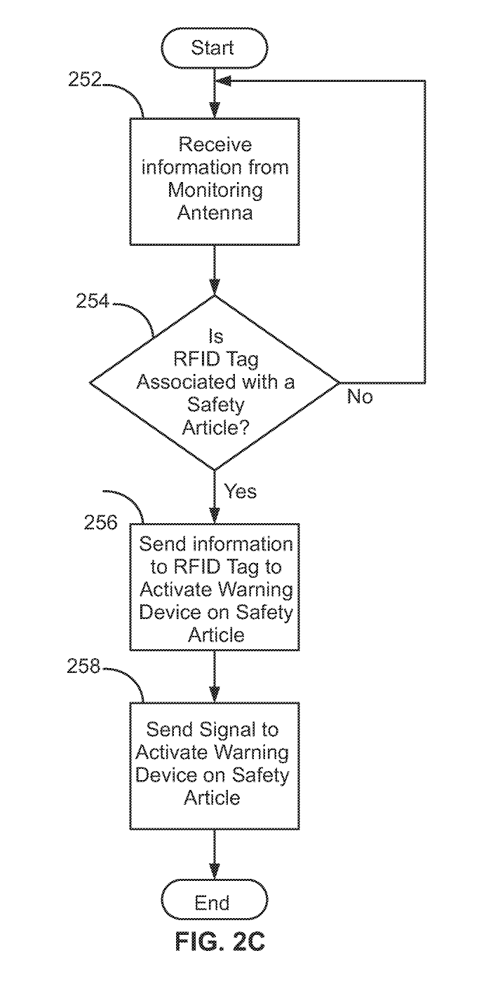

FIG. 5 illustrates another embodiment of the system in which a monitoring antenna mounted on a moving hazard such as a vehicle. In this embodiment the vehicle 500 moves in “transverse drive.” For the purposes of this disclosure, the term “transverse drive” means that the vehicle 500 moves sideways right to left and vice versa as represented by the arrow in FIG. 5. A vehicle that moves in transverse drive or transversely moves in a direction that is perpendicular to normal drive. Such a vehicle may have tires that move over the ground or may be mounted on devices, such as wheels, that move on rails. In an embodiment, the vehicle 500 may be a crane that is used to lift and move loads. The crane 500 may include four columns, one column at each corner 520, 522, 524, 526.

In the embodiment shown in FIG. 5, four monitoring antennas A₅, A₆, A₇, A_{g} are mounted on the vehicle 500. Each monitoring antenna A₅, A₆, A₇, A₈ is disposed on the vehicle 500 so that it detects signals within a particular detection zone or field of coverage 510, 512, 514, 516. In some embodiments, monitoring antennas A₅, A₆, A₇, A₈ may be positioned such that at least some monitoring antennas have overlapping detection zones (510 and 516; 512 and 514).

In the embodiment illustrated in FIG. 5, a monitoring antenna A₅, A₆, A₇, A₈ is mounted on each corner of the vehicle 500 and monitoring antennas A₅, A₈ are disposed such that the detection zone 510, 516 of each covers a portion of the left side of the vehicle 500. Monitoring antennas A₆, A₇ are disposed such that the detection zone 512, 514 of each covers a portion of the right side of the vehicle.

In other embodiments a greater or lesser number of monitoring antenna may be used depending on the size of the moving hazard and the detection coverage desired. In an embodiment involving a crane, it is preferred to mount, at a minimum, one monitoring antenna on each crane column 520, 522, 524, 526. Also, in the embodiment the monitoring antennas are mounted so that the left side antennas A₅, A₈ have overlapping detection zones 510, 516 and these detection zones combined cover the entire left vehicle side. Likewise, in the embodiment, the right side antennas A₆, A₇ have overlapping detection zones 512, 514 and these detection zones combined cover the entire right vehicle side. The processor 108 and database 110 in the embodiment shown in FIG. 5 are disposed in the cab 330 of the vehicle 500. In other embodiments, the processor 108 may be located elsewhere on the vehicle 500 or may be located remotely from the vehicle 500.

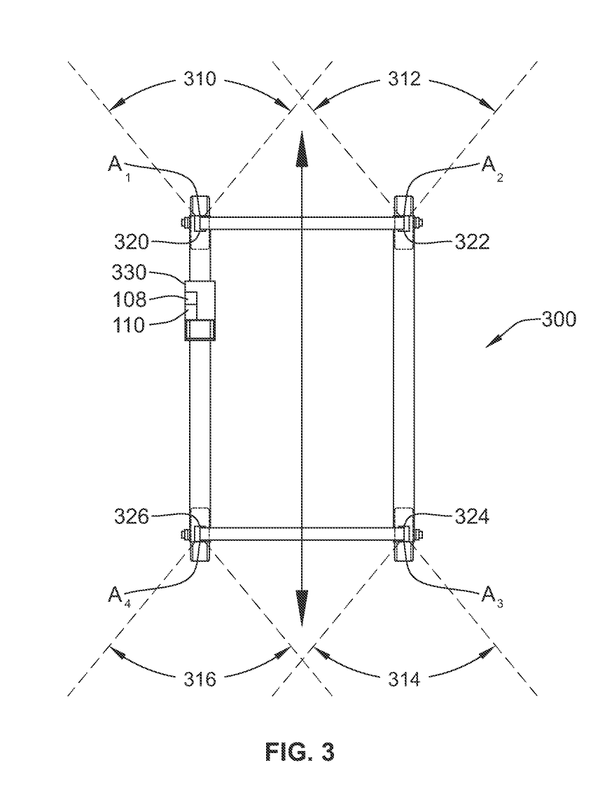

FIG. 6 illustrates the monitoring antennas A₅-A₈, processor 108, database 110 and warning device 112 for the embodiment of FIG. 5. As shown in FIGS. 5-6, the processor 108 communicates with each of the monitoring antennas A₅-A₈. If a monitoring antenna A₅-A₈ detects an RFID tag 104 within its detection zone, it transmits that information to the processor 108.

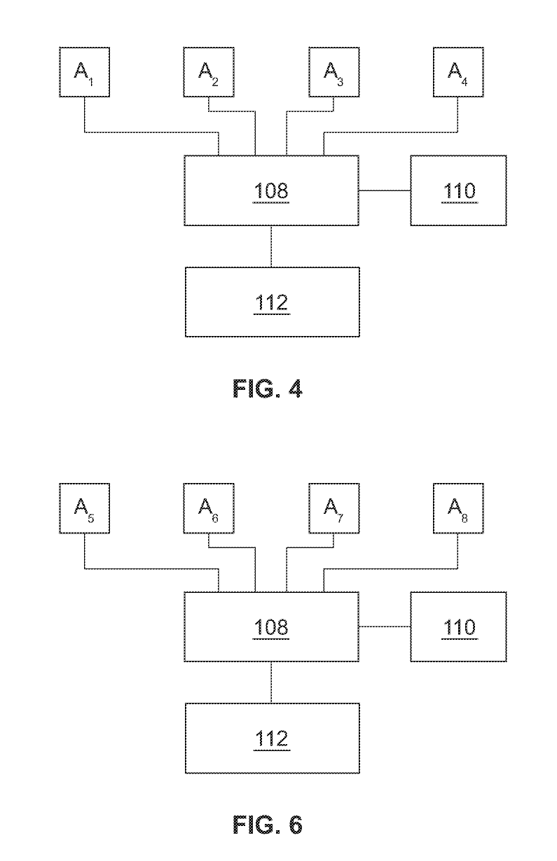

FIG. 7 illustrates a moving hazard that can move in normal and transverse drive directions (forward, backward, left, right). In the embodiment shown in FIG. 7, eight monitoring antennas A₁, A₂, A₃, A₄, A₅, A₆, A₇, A₈ are mounted on the vehicle 700. Each monitoring antenna A₁, A₂, A₃, A₄, A₅, A₆, A₇, A₈ is disposed on the vehicle 700 so that it detects signals within a particular detection zone or field of coverage 310, 312, 314, 316 (similar to that shown in FIG. 3) and 510, 512, 514, 516 (similar to that shown in FIG. 5).

In some embodiments, monitoring antennas A₁, A₂, A₃, A₄ may be positioned such that at least some monitoring antennas have overlapping fields of coverage (e.g., 310 and 312; 314 and 316). In the embodiment illustrated in FIG. 7, a monitoring antenna A₁, A₂, A₃, A₄ is mounted on each corner of the vehicle 700 and monitoring antennas A₁, A₂ are disposed such that the detection zone 310, 312 (similar to that shown in FIG. 3) of each covers at least a portion of the front side of the vehicle (forward drive direction). Similarly, monitoring antennas A₃, A₄ are disposed such that the detection zone 314, 316 (similar to that shown in FIG. 3) of each covers at least a portion of the back side of the vehicle (backward/reverse drive direction). In other embodiments a greater or lesser number of monitoring antenna may be used depending on the size of the vehicle and the coverage desired.

In an embodiment involving a crane, monitoring antennas may be mounted on the crane side beams 720, 722. In other embodiments the monitoring antennas may be mounted in other suitable places on the vehicle. Also, in this embodiment, some monitoring antennas may be mounted on the ends of each side beam 720, 722 so that the front antennas A₁, A₂ may have overlapping detection zones 310, 312 and these detection zones combined may cover the entire front vehicle side (similar to that shown in FIG. 3) and the back antennas A₃, A₄ may have overlapping detection zones 314, 316 and these detection zones combined may cover the entire back vehicle side (similar to that shown in FIG. 3).

In some embodiments, monitoring antennas A₅, A₆, A₇, A₈ may be positioned such that at least some monitoring antennas may have overlapping fields of coverage (e.g., 510 and 516; 512 and 514). In the embodiment illustrated in FIG. 7, a monitoring antenna A₅, A₆, A₇, A₈ is mounted on each corner of the vehicle 700. Monitoring antennas A₅, A₈ may be disposed such that the detection zone 510, 516 of each covers at least a portion of the drive direction on the left side of the vehicle. Monitoring antennas A₆, A₇ may be disposed such that the detection zone 512, 514 of each covers at least a portion of the drive direction on the right side of the vehicle. In other embodiments a greater or lesser number of monitoring antenna may be used depending on the size of the vehicle and the coverage desired.

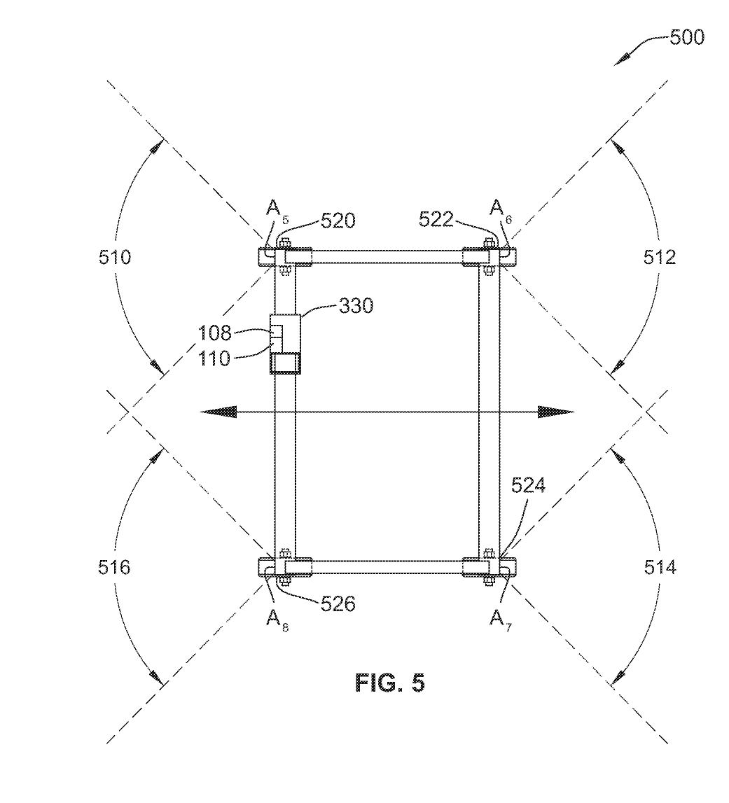

As noted previously, in one embodiment, monitoring antennas may be mounted on the crane side beams 720, 722. Also in the preferred embodiment, some monitoring antennas may be mounted adjacent to the ends of each side beam 720, 722 so that the left-side antennas A₅, A₈ may have overlapping detection zones 510, 516 and these detection zones combined may cover the entire left vehicle side (similar to that shown in FIG. 5) and, similarly, the right-side antennas A₆, A₇ may have overlapping detection zones 512, 514 and these detection zones combined may cover the entire right vehicle side (similar to that shown in FIG. 5). The processor 108 and database 110 in the embodiment shown in FIG. 8 are disposed in the cab 330 of the vehicle 700. In other embodiments, the processor 108 and the database 110 it accesses may be located elsewhere on the vehicle 700 or may be remote from the vehicle 700.

FIG. 8 illustrates the monitoring antennas A₁-A₈, processor 108, database 110 and warning device 112 for the embodiment of FIG. 7. As shown in FIGS. 7-8, the processor 108 communicates with each of the monitoring antennas A₁-A₈. If an antenna A₁-A₈ detects an RFID tag 104 within its field of coverage, it transmits that information to the processor 108.

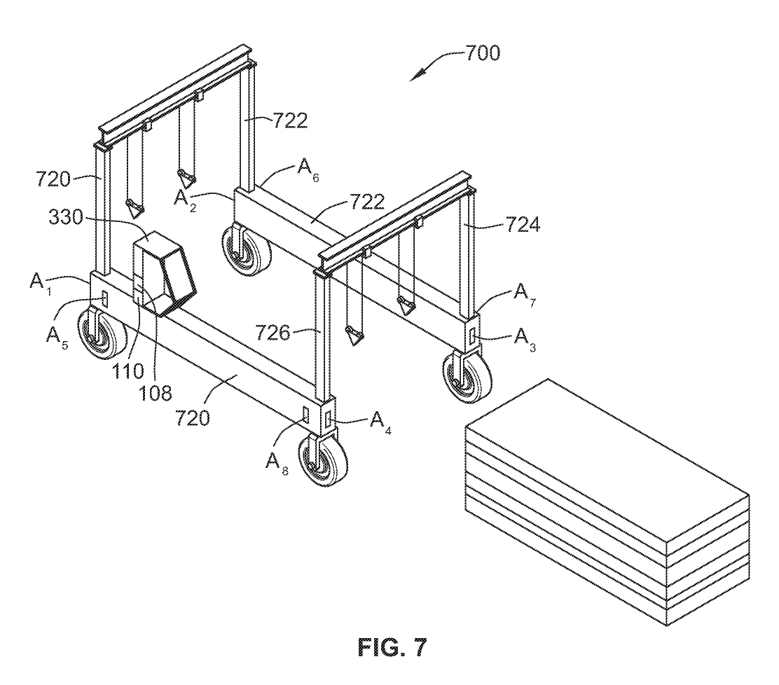

FIG. 9 illustrates a representation of a general industrial or construction vehicle, non-industrial vehicle or machine 900 for which the RFID system 100 may utilized. Such vehicles or machines may include, but are not limited to, forklift trucks, intermodal container lift trucks, front-end loaders, road scrapers, excavators, cars, vans, robots, track-type machines or the like. Such a vehicle or machine 900 move in a plurality of directions. Vehicles may utilize rubber tires, but are not limited to rubber tires, and may be driven on the ground, road, or any suitable surface. Machines may have a stationary base with components that move in a plurality of directions or may be mounted on a base that is not stationary.

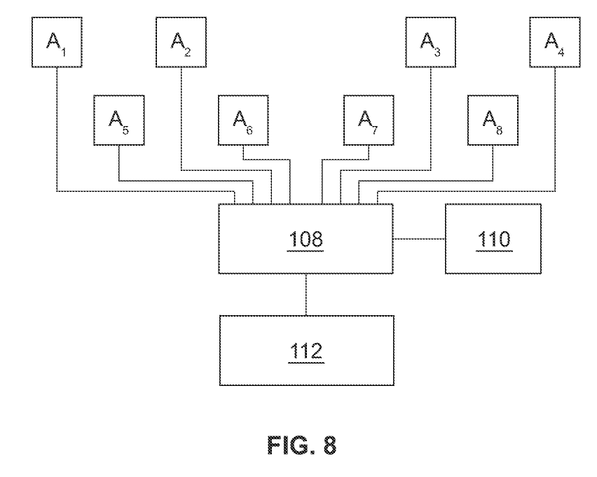

FIG. 10 illustrates one embodiment of such a vehicle 900 used in an RFID system 100 in which a monitoring antenna A is mounted on the vehicle 900. In the embodiment shown in FIG. 10, four monitoring antennas A₉, A₁₀, A₁₁, A₁₂ are mounted on the vehicle 900. Each monitoring antenna A₉-A₁₂ is disposed on the vehicle 900 so that it detects signals within a particular detection zone or area 910, 912, 914, 916. In some embodiments, monitoring antennas A₉-A₁₂ may be positioned such that at least some monitoring antennas have overlapping fields of coverage (e.g., 910 and 912; 914 and 916).

In the embodiment illustrated in FIG. 10, a monitoring antenna A₉-A₁₂ is mounted adjacent each corner of the vehicle 900 and monitoring antennas A₉, A₁₀ are disposed such that the detection zone 910, 912 of each covers, at a minimum, a portion of the drive direction in front of the vehicle 900. Monitoring antennas A₁₁, A₁₂ are disposed such that the detection zone 914, 916 of each covers, at a minimum, a portion of the drive direction at the back of the vehicle 900. In other embodiments a greater or lesser number of monitoring antenna may be used. In one embodiment, the monitoring antennas are mounted so that the front antennas A₉, A₁₀ have overlapping detection zones 910, 912 and these detection zones combined cover the entire front vehicle side. Similarly, the back antennas A₁₁, A₁₂ have overlapping detection zones 914, 916 and these detection zones combined cover the entire back vehicle side. The processor 108 and database 110 in the embodiment shown in FIG. 10 are disposed in or inside the vehicle 900. In other embodiments, the processor 108 and the database 110 it accesses may be located remotely from the vehicle 900.

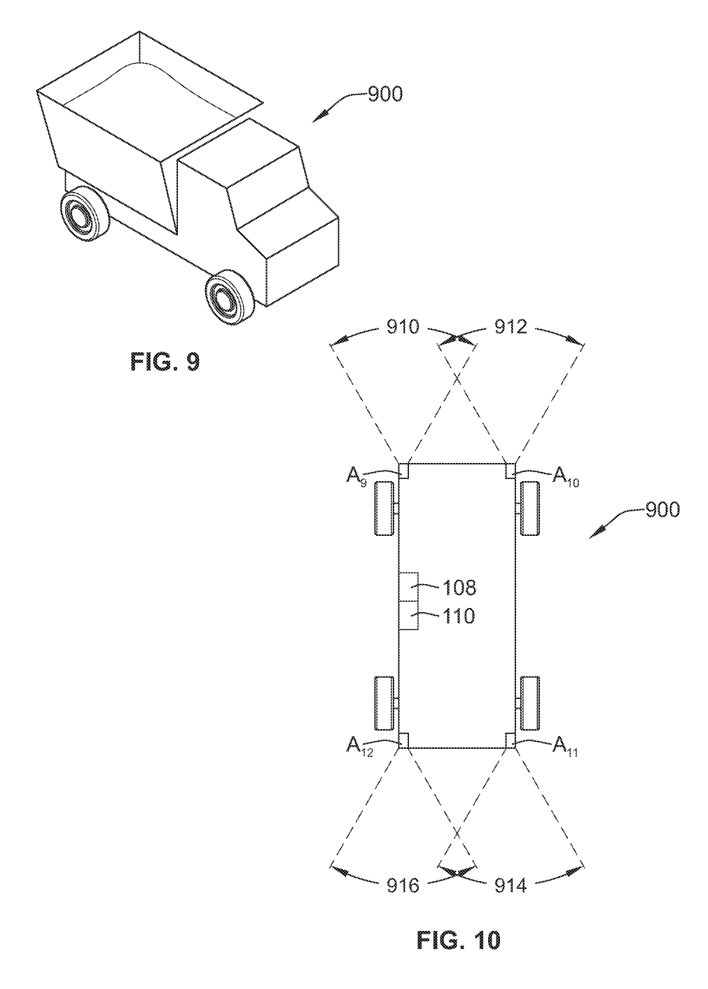

FIG. 11 illustrates the monitoring antennas A₉-A₁₂, processor 108, database 110 and warning device 112 for the embodiment of FIG. 10. As shown in FIGS. 10-11, the processor 108 communicates with each of the monitoring antennas A₉-A₁₂. If an antenna A₉-A₁₂ detects an RFID tag 104 within its field of coverage, it transmits that information to the processor 108.

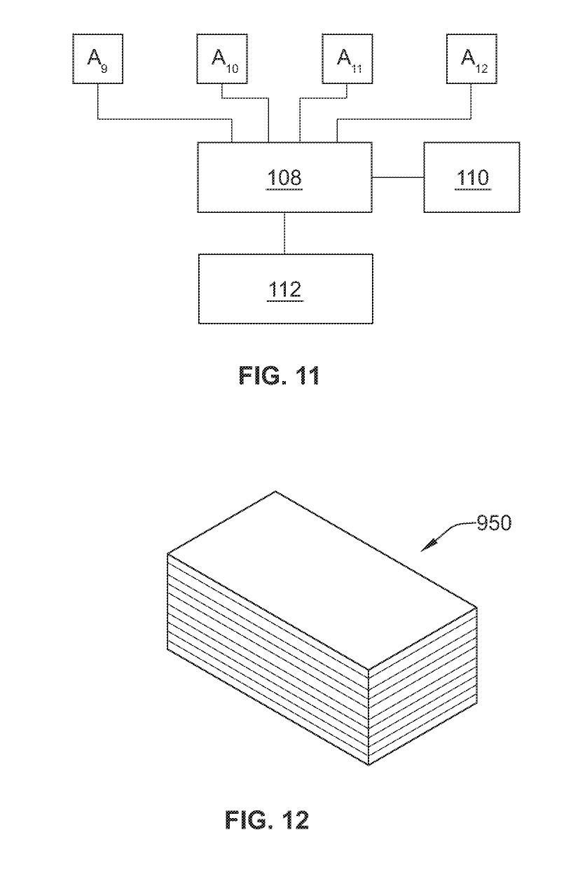

FIG. 12 illustrates an embodiment of a fixed hazard 950 for which the RFID system may utilized. The hazard 950 may be stacks of hot metal plates, vats of hazardous liquids, or a pit dug in the floor of an industrial facility. An array of “n” antennas per side may be utilized to achieve the desired detection coverage.

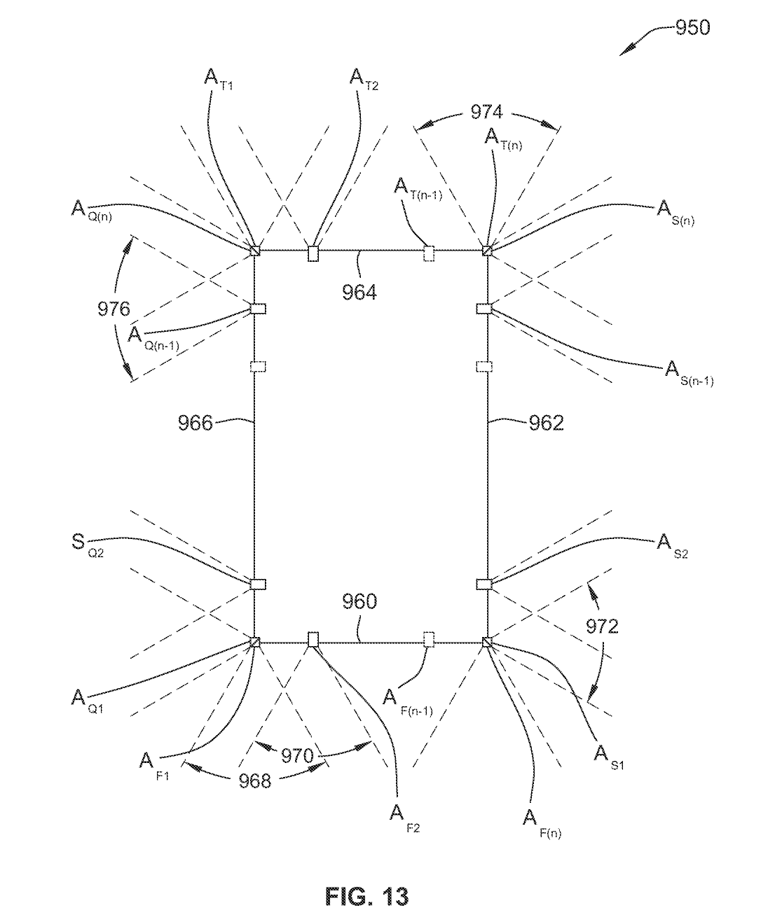

As shown in FIG. 13, a plurality of monitoring antennas may be mounted on the hazard or adjacent to the hazard. The number of monitoring antennas desired may be based upon the size of the perimeter of the hazard and the amount of detection coverage required for avoidance of the hazard.

In one embodiment, at least a portion of the monitoring antennas are disposed on or adjacent to each side of the hazard and may have overlapping fields of coverage. For example, in the embodiment illustrated in FIG. 13 in which the hazard 950 has four sides 960, 962, 964, 966. Each monitoring antenna A is disposed so that it detects signals within a particular detection zone or area (e.g. 968, 970, 972, 974, 976 etc.). In some embodiments, monitoring antennas may be positioned such that at least some monitoring antennas have overlapping fields of coverage (e.g. 968 and 970). In the embodiment shown in FIG. 13, the antennas along the first side 960 of the hazard 950 may have overlapping detection zones. The antennas along the second side 962 of the hazard 950 may have overlapping detection zones. The antennas along the third side 964 of the hazard 950 may have overlapping detection zones and the antennas along a fourth side 966 of the hazard 950 may have overlapping detection zones. Overlapping detection zones are not required but are preferred.

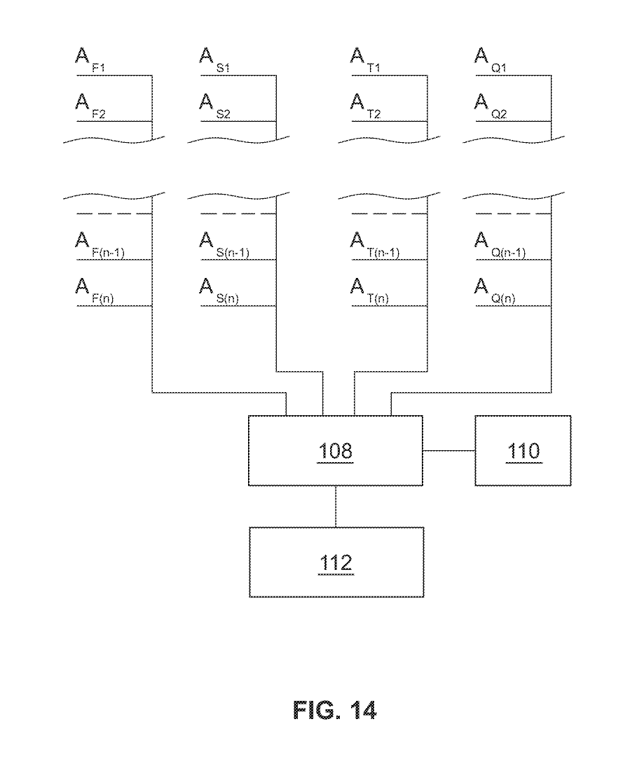

The quantity of monitoring antennas along the first side is A_{F1}, A_{F2}, A_{F(n-1)}, A_{F(n)} where “F” is the first side and “n” is the nth monitoring antenna. Similarly, the quantity of monitoring antennas along the second side is A_{S1}, A_{S2} . . . A_{S(n-1)}. A_{S(n)} where “S” is the second side and “n” is the nth monitoring antenna. The quantity of monitoring antennas along the third side is A_{T1}, A_{T2} . . . A_{T(n-1)}. A_{T(n)} where “T” is the third side and “n” is the nth monitoring antenna. The quantity of monitoring antennas along the fourth side is A_{Q1}, A_{Q2} . . . A_{Q(n-1)}, A_{Q(n)} where “Q” is the fourth side and “n” is the nth monitoring antenna. While the embodiment shown in FIG. 13 illustrates a hazard with four sides, the system 100 may also be used with hazards of greater or fewer sides. In the embodiment illustrated in FIG. 13, a monitoring antenna A_{F1}, A_{F(n)}, A_{S1}, A_{S(n)}, A_{T1}, A_{T(n)}, A_{Q1}, A_{Q(n)} is mounted adjacent each corner of the hazard 950. The processor 108 and database 110 in the embodiment shown in FIG. 14 may be disposed near or remote from the hazard 950.

FIG. 14 illustrates the plurality of monitoring antennas A, processor 108, database 110 and warning device 112 for the embodiment of FIG. 13. As shown in FIGS. 13-14, the processor 108 communicates with each of the monitoring antennas A (e.g. A_{F1}. A_{F2}, . . . A_{F(n-1)}, A_{F(n)}; A_{S1}, A_{S2}, . . . A_{S(n-1)}, A_{S(n)}; A_{T1}, A_{T2}, . . . A_{T(n-1)}, A_{T(n)}; and A_{Q1}, A_{Q2}, . . . A_{Q(n-1)}, A_{Q(n)}. If an antenna A detects an RFID tag 104 within its field of coverage, it transmits that information to the processor 108. The processor 108 determines if the RFID tag 104 is for a safety article 102 and the hazard to be avoided. The processor 108 will transmit a signal to activate a warning device 112 if the wearer of the safety article 102 is determined to be in the proximity of the hazard. Such a warning device 112 may include, but is not limited to, a horn, lights etc.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indiated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A method for detecting and warning of the proximity of a hazard, the method comprising:
receiving a signal from a first RFID tag;
determining that the first RFID tag is associated with a safety article; and
transmitting a signal to activate a warning device.

2. The method of claim 1, wherein the safety article is a vest.

3. The method of claim 1, further comprising:
determining the hazard for which a user of the safety article is to be warned; and
determining that the user is in proximity to the hazard, wherein the warning device is a horn.

4. The method of claim 1, wherein the receiving step is performed by a monitoring antenna mounted on the hazard.

5. The method of claim 4, wherein the hazard is a moving vehicle and the warning device is a display inside the moving vehicle that identifies a location of the safety article in relation to the moving vehicle.

6. The method of claim 4 further comprising providing first and second detection zones on a first side of the hazard and third and fourth detection zones on a second side of the hazard.

7. The method of claim 6, wherein the first and second detection zones partially overlap and the third and fourth detection zones partially overlap.

8. The method of claim 1, wherein the hazard is a gantry crane.

9. The method of claim 1, wherein the receiving step is performed by a RF monitoring antenna mounted proximal to the hazard, wherein the hazard is stationary.

10. A system for detecting and warning of the proximity of a hazard, the system comprising:
a plurality of RFID tags coupled to a safety article, the plurality of RFID tags including a first RFID tag that transmits data to a first monitoring antenna, the data including the identification of the first RFID tag;
a plurality of monitoring antennas, mounted on a vehicle, the plurality of monitoring antennas including a first monitoring antenna that receives the data transmitted from the first RFID tag; and
a first processor, coupled to at least one of the plurality of monitoring antennas, that transmits a signal to activate a first warning device based on the identification of the first RFID tag.

11. The system of claim 10 wherein the vehicle moves in the forward direction and the backward direction.

12. The system of claim 10, wherein the vehicle is a gantry crane comprising a plurality of columns, and each of the plurality of monitoring antennas is mounted on a different column.

13. The system of claim 10, wherein the vehicle moves transversely.

14. The system of claim 13, wherein the vehicle moves in the forward direction and the backward direction and plurality of monitoring antennas is eight monitoring antennas.

15. The system of claim 14, wherein there are two detection zones on each side of the vehicle.

16. The system of claim 15, wherein the detection zones on each side of the vehicle overlap.

17. The system of claim 10 further comprising a second warning device disposed on the safety article and connected to the first RFID tag, wherein the first processor transmits a signal to the first RFID tag to cause activation of the second warning device, wherein further the safety article is a vest and at least one of the plurality of RFID tags is disposed on a front side of the vest and another of the plurality of RFID tags is disposed on a back side of the vest.

18. A system for detecting and warning of the proximity of a hazard, the system comprising:
first and second RFID tags embedded in a safety article worn by a user, the first tag embedded in the front of the safety article and the second tag embedded in the back of the safety article;
a plurality of monitoring antennas, mounted adjacent to a stationary hazard, the plurality including a first monitoring antenna that provides a first detection zone and that receives data transmitted from the first RFID tag when the first RFID is present in the first detection zone;
a database that stores computer-readable instructions;
a computer processor that executes the computer-readable instructions to determine, based on the data received from the RFID tag, whether the RFID tag is associated with a safety article; and
a warning device that is activated by the processor if the safety article is detected by the first monitoring antenna.

19. The system of claim 18, wherein the safety article is a garment.

20. The system of claim 18, wherein the warning device is a horn.
